(19) United States
(12) Patent Application Publication
(10) Pub. No.: US 2023/0399513 A1
(43) Pub. Date: Dec. 14, 2023

(54) MIXTURES CONTAINING PHOSPHORUS COMPOUNDS AND USE THEREOF

(71) Applicant: WACKER CHEMIE AG, Munich (DE)

(72) Inventors: Peter Schöley, Diera-Zehren OT Kleinzadel (DE); Stephan Marrack, Weinböhla (DE); Uwe Scheim, Coswig (DE)

(73) Assignee: Wacker Chemie AG, Munich (DE)

(21) Appl. No.: 18/278,753

(22) PCT Filed: Feb. 26, 2021
(86) PCT No.: PCT/EP2021/054778

§ 371 Date: Aug. 24, 2023

(51) Int. Cl. C08L 83/08; C08G 77/06; C08K 5/5317; C08G 77/30

(52) U.S. Cl. CPC C08L 83/08; C08G 77/06; C08K 5/5317; C08G 77/30; C08G 2190/00

(57) ABSTRACT

Compositions and mixtures along with processes for preparing and uses for the same.

The invention relates to phosphorus compound-containing mixtures, processes for the preparation thereof and use thereof, particularly in crosslinkable compositions based on organosilicon compounds and processes for preparing organosilicon compounds comprising organyloxy groups.

One-component sealing compounds, which are storable with the exclusion of water and cure to give elastomers on ingress of water at room temperature with the elimination of alcohols, are already known. These products are used in large amounts, for example in the construction industry. The basis of these mixtures are polymers terminated by silyl groups, which bear reactive substituents such as OH groups or hydrolysable groups such as alkoxy groups. Furthermore, these sealing compounds may contain fillers, plasticizers, crosslinkers, catalysts and various additives. Alkoxysilanes are often used as crosslinkers. These sealing compounds require catalysts based on tin or titanium to accelerate curing.

Zinc catalysts often used are, for example, dibutyltin dilaurate, dibutyltin diacetate, dioctyltin dioxide and reaction products thereof with alkoxysilanes. However, RTV1 sealing compounds produced using alkoxysilanes have disadvantages. After only a few months, they no longer cure fully. EP 1 397 428 B1 therefore proposes various organophosphorus compounds to significantly improve storage stability. Unfortunately, however, the phosphorus compounds that are particularly suitable for stabilizing RTV1 sealing compounds, octylphosphonic acid for example, are solids at room temperature. In operational use, however, liquids are strongly preferred because they are much better suited for metered addition than solids, especially in continuous processes. For instance, in EP 2 030 675 B1, a readily manageable liquid solution of n-octylphosphonic acid in methyltrimethoxysilane is used.

A particular disadvantage of methyltrimethoxysilane, however, is that it has a very low flash point. Therefore, when handling methyltrimethoxysilane, complex undesirable safety measures are required. Also, it is not always ensured that no undesired reaction products are formed in mixtures of n-octylphosphonic acid and methyltrimethoxysilane.

Furthermore, the use of n-octylphosphonic acid and neutralizing agent in the production of polymers having hydrolysable end groups is known. EP 3 344 684 B1 de-scribes the reaction of terminal silanol groups of linear polydimethylsiloxanes with alkoxysilanes. 1,5,7-Triazabicyclo[4.4.0]dec-5-ene is used as catalyst. In the examples, after the reaction, the catalyst is neutralized in a second step with n-octylphosphonic acid. Also used here is the disadvantageous variant of a solution of n-octylphosphonic acid in methyltrimethoxysilane.

The object of the invention was to overcome the disadvantages of the prior art.

The invention therefore provides mixtures (M) comprising (X) polyethers of the general formula

R¹—(O—R ²)ₚ—O—R¹ (I),

wherein
R¹ may be identical or different and denotes a hydrogen atom or hydrocarbon radicals,
R² may be identical or different and denotes divalent, optionally substituted hydrocarbon radicals and
p is an integer from 4 to 110,
(Y) phosphorus compounds of the formula

O═PR⁵ₘ(OR⁶)ₙ(OH)₃₋₍ₘ₊ₙ₎ (II),

wherein
R⁵ may be identical or different and denotes optionally substituted hydrocarbon radicals,
R⁶ may be identical or different and denotes optionally substituted hydrocarbon radicals,
m is equal to 0 or 1, preferably 1, and
n is equal to 0, 1 or 2,

with the proviso that m+n is equal to 1 or 2, preferably 1,

and optionally
(Z) water.

Examples of radicals R¹ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl and cycloheptyl radical and methylcyclohexyl radicals; alkenyl radicals such as the vinyl, 1-propenyl and 2-propenyl radical; aryl radicals such as the phenyl, naphthyl, anthryl and phenanthryl radical; alkaryl radicals such as o-, m-, p-tolyl radicals; xylyl radicals and ethylphenyl radicals; and aralkyl radicals such as the benzyl radical or the α- and β-phenylethyl radicals.

The radicals R¹ are preferably a hydrogen atom or alkyl radicals having 1 to 18 carbon atoms, particularly preferably a hydrogen atom.

Examples of divalent radicals R² are alkylene radicals such as the ethane-1,2-diyl, propane-1,2-diyl, propane-1,3-diyl, butane-1,4-diyl, butane-1,3-diyl, 2-methylpropane-1,3-diyl, pentane-1,5-diyl, pentane-1,4-diyl, 2-methylbutane-1,4-diyl, 2,2-dimethylpro-pane-1,3-diyl, hexane-1,6-diyl, heptane-1,7-diyl, octane-1,8-diyl and 2-methylheptane-1,7-diyl and 2,2,4-trimethylpentane-1,5-diyl radical.

The radicals R² are preferably divalent hydrocarbon radicals having 2 to 4 carbon atoms, particularly preferably the propane-1,2-diyl radical.

The index p is preferably an integer from 4 to 65.

The polyethers (X) used according to the invention are preferably those of the formula

R¹(OCH₂CH₂)_{q}(OCHCH₃CH₂)ᵣ(OCH₂CH₂)ₛOR¹ (III),

wherein
R¹ has one of the aforementioned definitions,
q is 0 or an integer from 1 to 30, preferably 0 or an integer from 1 to 15,
s is 0 or an integer from 1 to 30, preferably 0 or an integer from 1 to 15, and
r is an integer from 4 to 50, preferably an integer from 4 to 35.

Examples of compounds (X) used according to the invention are
H(OCH₂CH₂)₅(OCHCH₃CH₂)(OCH₂CH₂)₁₀OH,
H(OCH₂CH₂)₆(OCHCH₃CH₂)(OCH₂CH₂)₇OH,
H(OCH₂CH₂)₅(OCHCH₃CH₂)(OCH₂CH₂)₂₀OH,
H(OCH₂CH₂)₇(OCHCH₃CH₂)(OCH₂CH₂)₇OH,
H(OCH₂CH₂)₂(OCHCH₃CH₂)(OCH₂CH₂)₁₂OH,
H(OCH₂CH₂)₅(OCHCH₃CH₂)₂(OCH₂CH₂)₁₀OH,
H(OCH₂CH₂)₆(OCHCH₃CH₂)₂(OCH₂CH₂)₆OH,
CH₃(OCH₂CH₂)₅(OCHCH₃CH₂)(OCH₂CH₂)₁₀OCH₃,
CH₃(OCH₂CH₂)₆(OCHCH₃CH₂)(OCH₂CH₂)₇OCH₃,
CH₃(OCH₂CH₂)₅(OCHCH₃CH₂)(OCH₂CH₂)₂₀OCH₃,
CH₃(OCH₂CH₂)₇(OCHCH₃CH₂)(OCH₂CH₂)₇OH,
CH₃(OCH₂CH₂)₂(OCHCH₃CH₂)(OCH₂CH₂)₁₂OH,
CH₃(OCH₂CH₂)₅(OCHCH₃CH₂)₂(OCH₂CH₂)₁₀OH and
CH₃(OCH₂CH₂)₅(OCHCH₃CH₂)₂(OCH₂CH₂)₆OH,

where particular preference is given to H(OCHCH₃CH₂)ₚOH, CH₃(OCHCH₃CH₂)ₚOH or CH₃(OCHCH₃CH₂)ₚOCH₃.

In particular, the polyethers (X) used according to the invention are those of the formula

H(OCHCH₃CH₂)ᵣOH (IV)

where r has the definition stated above.

The mixtures (M) according to the invention comprise polyethers (X) in amounts of preferably 40 to 90 parts by weight, particularly preferably 50 to 70 parts by weight, based in each case on 100 parts by weight of the mixture (M).

Polyethers (X) are commercially available products or may be prepared by common methods in organic chemistry.

Examples of radicals R⁵ are the radicals specified for R¹.

The radicals R⁵ are preferably linear or branched alkyl radicals having 4 to 16 carbon atoms, aryl radicals or the vinyl radical, particularly preferably linear or branched alkyl radicals having 4 to 16 carbon atoms, especially the n-octyl radical.

Examples of R⁶ are the radicals specified for R¹ and radicals interrupted by oxygen such as R¹—(O—CH₂CH₂)₃—, R¹—(O—CH₂CH₂)₄—, R¹—(O—CH₂CH₂)₅— and R¹—(O—CH₂CH₂)₆—, n-C₁₂H₂₅—(O—CH₂CH₂)_{z}—, n-C₁₄H₂₉—(O—CH₂CH₂)_{z}-, n-C₁₆H₃₃—(O—CH₂CH₂)_{z}— and n-C₁₈H₃₇—(O—CH₂CH₂)_{z}— where z is 4 to 25.

The radicals R⁶ are preferably linear or branched alkyl radicals having 1 to 18 carbon atoms or alkyl radicals having 10 to 68 carbon atoms interrupted by oxygen.

Examples of phosphorus compounds (Y) used according to the invention are alkylphosphonic acids such as butylphosphonic acid, sec-butylphosphonic acid, isobutylphosphonic acid, tert-butylphosphonic acid, n-pentylphosphonic acid, n-hexylphosphonic acid, n-heptylphosphonic acid, n-octylphosphonic acid, n-nonylphosphonic acid, n-decylphosphonic acid, n-un-decylphosphonic acid, n-dodecylphosphonic acid, n-tridecylphosphonic acid, n-tetradecylphosphonic acid, n-pentadecylphosphonic acid, n-hexadecylphosphonic acid, benzylphosphonic acid, 2-phenylethylphosphonic acid, arylphosphonic acids such as phenylphosphonic acid, 1-naphthylphosphonic acid, phosphoric acid monoes-ters such as methyl phosphate, ethyl phosphate, n-propyl phosphate, isopropyl phosphate, n-butyl phosphate, n-pentyl phosphate, n-hexyl phosphate, n-heptyl phosphate, n-octyl phosphate, 2-ethylhexyl phosphate, n-decyl phosphate, n-dodecyl phosphate, n-tetradecyl phosphate, n-hexadecyl phosphate, phosphoric acid diesters such as dimethyl phosphate, diethyl phosphate, di-n-butyl phosphate, di-n-hexyl phosphate, di-n-octyl phosphate, di-2-ethylhexyl phosphate, di-n-decyl phosphate, di-n-dodecyl phosphate, di-n-tetradecyl phosphate, di-n-hexadecyl phosphate, polyoxyethylene alkyl phosphates such as polyoxyethylene lauryl phosphate, polyoxyethylene cetyl phosphate, polyoxyethylene stearyl phosphate, each having 4 to 25 oxyethylene units.

The phosphorus compounds (Y) used according to the invention are preferably alkylphosphonic acids having 4 to 18 carbon atoms, particularly preferably n-octylphosphonic acid.

Phosphorus compounds (Y) are commercially available products. For example, n-octylphosphonic acid is obtainable as pure substance or also as a solution in ethanol and water, for example under the name “Hostaphat OPS 100” (pure product) or “Hostaphat OPS 75” (solution in ethanol and water) from Clariant.

The mixtures (M) according to the invention comprise phosphorus compounds (Y) in amounts of preferably 10 to 50 parts by weight, particularly preferably 25 to 35 parts by weight, based in each case on 100 parts by weight of the mixture (M).

The mixtures (M) according to the invention preferably comprise water (Z).

The mixtures (M) according to the invention comprise water (Z) in amounts of preferably 0.5 to 3.0 mol, particularly preferably 1.0 to 2.0 mol, especially 1.0 to 1.5 mol, based in each case on 1 mole of phosphorus compound (Y), preferably n-octylphosphonic acid.

In addition to components (X), (Y) and (Z), the mixtures (M) according to the invention may comprise further constituents, such as alcohols, particularly ethanol.

The mixtures (M) according to the invention preferably consist to an extent of at least 98% by weight, particularly preferably to an extent of at least 99.8% by weight, especially to an extent of 100% by weight, of the components (X), (Y) and (Z).

The mixtures (M) according to the invention are colourless to pale yellow liquids or low-melting solids and have a melting point of preferably <35° C., particularly preferably <0° C., especially ≤−30° C.

To prepare the mixtures (M) according to the invention, all constituents can be mixed with one another in any sequence. This mixing may be carried out at room temperature or elevated temperature of 30° C. to 150° C. and at the pressure of the ambient atmosphere, i.e. about 900 to 1100 hPa, or at a reduced pressure of 1 to 900 hPa.

The invention further provides a process for preparing the mixtures (M) according to the invention by mixing the individual constituents.

In the process according to the invention, polyether (X) is preferably initially charged in a suitable vessel and then the phosphorus compound (Y) is metered in with stirring. This is preferably done at ambient temperature. Subsequently, while stirring and at reduced pressure of up to 20 mbar, the mixture is preferably heated to a temperature of 80 to 150° C. and impurities present, such as water and alcohols, are removed by distillation. The temperature and reduced pressure are preferably maintained until distillate no longer passes over. The mixture is then cooled to room temperature and, if desired, a defined amount of water (Z) is added.

The process according to the invention may be carried out continuously, discontinuously or semi-continuously by known methods and using known apparatuses.

It was not expected that the phosphorus compounds (Y) can be dissolved in polyethers (X) without visible residues up to a concentration of 50% by weight. For usability in practice, it is necessary that the n-octylphosphonic acid does not crystallize out of the mixture even at low temperatures. It was particularly surprising that the addition of defined amounts of water (Z) again significantly improves the stability of the mixture (M) even down to temperatures of −30° C.

The mixtures (M) according to the invention have the advantage that they enable handling as a liquid with low hazard potential without the formation of undesirable by-products.

Furthermore, the mixtures (M) according to the invention have the advantage that they are readily preparable without formation of undesirable by-products.

The mixtures (M) according to the invention have the advantage that they are liquid, even at low temperatures, and have a low flash point.

The mixtures (M) according to the invention have the advantage that they exhibit good storage stability and have high resistance to low temperatures.

The mixtures (M) according to the invention may be used for all applications for which phosphorus compounds may also be used to date, such as, for example, as stabilisers for compositions based on organosilicon compounds which can be crosslinked with elimination of alcohol.

Mixtures (M) according to the invention are preferably used for preparing crosslinkable compositions based on organosilicon compounds.

The invention further provides crosslinkable compositions based on organosilicon compounds obtainable by mixing
(A) organopolysiloxanes of the formula

(R⁷O)₃₋ₐSiR³ₐO(SiR⁴₂O)ₙSiR³ₓ(OR⁷)₃₋ₐ (V),

wherein
R⁴ may be identical or different and denotes monovalent, optionally substituted hydrocarbon radicals,
R⁷ may be identical or different and denotes monovalent, optionally substituted hydrocarbon radicals,
R³ may be identical or different and denotes monovalent, optionally substituted hydrocarbon radicals,
a may be identical or different and is 0 or 1, preferably 1, and
x is an integer from 30 to 2000,
and
(B) mixtures (M) comprising
   (X) polyethers of the general formula (I),
   (Y) phosphorus compounds of the formula (II)
   and optionally
   (Z) water.

Examples of radicals R⁴ and R⁷ are each independently the radicals specified above for the radical R¹.

The radicals R⁴ are preferably each independently monovalent hydrocarbon radicals having 1 to 18 carbon atoms, particularly preferably a methyl, vinyl or phenyl radical, especially the methyl radical.

The radicals R⁷ are preferably each independently alkyl radicals having 1 to 12 carbon atoms, particularly preferably methyl, ethyl, n-propyl or isopropyl radicals, especially the methyl or ethyl radical.

Examples of radicals R³ are the monovalent hydrocarbon radicals specified for R¹ and hydrocarbon radicals substituted by amino groups.

The radical R³ is preferably a monovalent hydrocarbon radical having 1 to 12 carbon atoms, optionally substituted by amino groups, particularly preferably a methyl radical, ethyl radical, vinyl radical, phenyl radical, —CH₂—NR^{6′}R^{5′} radical or the radical —CH₂NR^{11′}, where R⁵ signifies hydrocarbon radicals having 1 to 12 carbon atoms, R⁶ signifies a hydrogen atom or radical R⁵ and R¹¹ signifies divalent hydrocarbon radicals which may be interrupted by heteroatoms.

The radical R³ is particularly preferably a radical —CH₂—NR^{6′}R^{5′} or a radical —CH₂NR^{11′} where R^{5′}, R^{6′} and R^{11′} are as defined above, in particular —CH₂—N[(CH₂)₂]₂O, —CH₂—N(Bu)₂ or —CH₂—NH(cHex), where Bu signifies an n-butyl radical and cHex signifies a cyclohexyl radical.

Examples of radicals R^{5′} are the hydrocarbon radicals specified for R¹.

The radical R^{5′} is preferably the methyl, ethyl, isopropyl, n-propyl, n-butyl, cyclohexyl or phenyl radical, particularly preferably the n-butyl radical.

Examples of hydrocarbon radicals R⁶ are the hydrocarbon radicals specified for R¹.

The radical R^{6′} is preferably a hydrogen atom, the methyl, ethyl, isopropyl, n-propyl, n-butyl or cyclohexyl radical, particularly preferably the n-butyl radical.

Examples of divalent radicals R¹¹ are the examples specified for R² and also the radicals —CH₂—CH₂—O—CH₂—CH₂— and —CH₂—CH₂—NH—CH₂—CH₂—.

The radicals R^{11′} are preferably divalent hydrocarbon radicals having 4 to 6 carbon atoms, which may be interrupted by heteroatoms, preferably oxygen —O— or nitrogen —NH—, particularly preferably —CH₂—CH₂—O—CH₂—CH₂—.

The organopolysiloxanes (A) used in accordance with the invention are preferably
(MeO)₂Si(Ox)O(SiMe₂O)₃₀₋₂₀₀₀Si(Ox)(OMe)₂,
(MeO)₂Si(DBA)O(SiMe₂O)₃₀₋₂₀₀₀Si(DBA)(OMe)₂,
(MeO)₂Si(cHx)O(SiMe₂O)₃₀₋₂₀₀₀Si(cHx)(OMe)₂,
(MeO)₂Si(R³)O(SiMe₂O)₇₀₀Si(R³)(OMe)₂,
(EtO)₂Si(Ox)O(SiMe₂O)₃₀₋₂₀₀₀Si(Ox)(OEt)₂,
(EtO)₂Si(DBA)O(SiMe₂O)₃₀₋₂₀₀₀Si(DBA)(OEt)₂,
(EtO)₂Si(cHx)O(SiMe₂O)₃₀₋₂₀₀₀Si(cHx)(OEt)₂ or
(EtO)₂Si(R³)O(SiMe₂O)₇₀₀Si(R³)(OEt)₂,
more preferably
(EtO)₂Si(Ox)O(SiMe₂O)₃₀₋₂₀₀₀Si(Ox)(OEt)₂,
(EtO)₂Si(DBA)O(SiMe₂O)₃₀₋₂₀₀₀Si(DBA)(OEt)₂ or
(EtO)₂Si(cHx)O(SiMe₂O)₃₀₋₂₀₀₀Si(cHx)(OEt)₂,
especially (EtO)₂Si(Ox)O(SiMe₂O)₃₀₋₂₀₀₀Si(Ox)(OEt)₂,

where Me is a methyl radical, Et an ethyl radical, Ox is —CH₂—N[(CH₂)₂]₂O, DBA is —CH₂—N(nBu)₂, cHx is —CH₂—NH(cHex), Bu is an n-butyl radical and cHex is a cyclohexyl radical, and R³ signifies Me, Et, vinyl radical, phenyl radical, DBA, Ox or cHx, where the radicals R³ have an identical definition within the individual compounds.

The organopolysiloxanes (A) used in accordance with the invention have a viscosity of preferably 6000 to 350 000 mPas, particularly preferably 20 000 to 120 000 mPas, in each case at 25° C.

The organopolysiloxanes (A) are commercially available products or they may be prepared by a method described below.

The component (B) used in accordance with the invention is preferably a mixture (M) comprising water (Z).

The compositions according to the invention comprise component (B) in amounts of preferably 0.001 to 5 parts by weight, particularly preferably 0.01 to 5 parts by weight, especially 0.1 to 1 part by weight, based in each case on 100 parts by weight of component (A).

The compositions according to the invention, in addition to the siloxanes (A) and (B), may comprise a component (C) consisting of silanes of the formula

(R⁸O)_{4-b}SiR⁹_{b} (VI)
and/or partial hydrolysates thereof, where
b is 0, 1 or 2, preferably 0 or 1,
R⁸ may be identical or different and denotes monovalent, optionally substituted hydrocarbon radicals and
R⁹ signifies monovalent, optionally substituted hydrocarbons.

The radicals R⁸ are preferably alkyl radicals having 1 to 12 carbon atoms, particularly preferably methyl, ethyl, n-propyl or isopropyl radicals, especially the methyl or ethyl radical.

The radical R⁹ is preferably a monovalent hydrocarbon radical having 1 to 18 carbon atoms, optionally substituted by glycidoxy, ureido, methacryloxy or amino groups, particularly preferably an alkyl radical, the vinyl radical or the phenyl radical, especially the methyl radical or the 2,2,4-trimethylpentyl radical.

In a preferred embodiment, silanes and/or partial hydrolysates thereof having functional groups, such as those having glycidoxypropyl, aminopropyl, aminoethyla-minepropyl, ureidopropyl or methacryloxypropyl radicals, are used in whole or in part as component (C), especially when adhesion-promoting properties are desired.

The partial hydrolysates (C) optionally used may be partial homohydrolysates, i.e. partial hydrolysates of one type of silanes of the formula (III), and also partial co-hydrolysates, i.e. partial hydrolysates of at least two different types of silanes of the formula (III).

In the context of the invention, the term partial hydrolysates is understood to mean products formed by hydrolysis and/or condensation.

If the component (C) optionally used in the compositions according to the invention is a partial hydrolysate of silanes of the formula (VI), those having up to 20 silicon atoms are preferred.

Examples of component (C) optionally used according to the invention are methyltrimethoxysilane, vinyltrimethoxysilane, phenyltrimethoxysilane, 2,2,4-trimethylpentyltrimethoxysilane, methyltriethoxysilane, vinyltriethoxysilane, phenyltriethoxysilane, tetraethoxysilane, 2,2,4-trimethylpentyltriethoxysilane, (2,3,5,6-tetrahydro-1,4-oxazin-4-yl)methyltriethoxysilane, N, N-di-n-butylaminomethyltriethoxysilane, N-cyclohexyla-minomethyltriethoxysilane, (2,3,5,6-tetrahydro-1,4-oxazin-4-yl)methyltrimethoxysilane, N,N-di-n-butylaminomethyltrimethoxysilane, N-cyclohexylaminomethyltrimethox-ysilane, wherein preference is given to methyltrimethoxysilane, vinyltriethoxysilane, tetraethoxysilane, 2,2,4-trimethylpentyltrimethoxysilane, (2,3,5,6-tetrahydro-1,4-oxa-zin-4-yl)methyltriethoxysilane.

Component (C) is a commercially available product or it may be prepared by methods common in silicon chemistry.

If the compositions according to the invention comprise component (C), the amounts involved are preferably from 0.01 to 5 parts by weight, particularly preferably from 0.01 to 2 parts by weight, especially from 0.05 to 2 parts by weight, based in each case on 100 parts by weight of component (A). The compositions according to the invention preferably comprise component (C), which preferably comprises at least in part silanes and/or partial hydrolysates thereof having functional groups.

In addition to components (A), (B) and optionally (C), the compositions according to the invention may now comprise all substances which have also been used so far in compositions crosslinkable by condensation reactions, such as curing accelerators (D), plasticisers (E), fillers (F) and additives (G).

All curing accelerators that have also been used to date in compositions crosslinkable by condensation reactions can be used as curing accelerators (D). Examples of curing accelerators (D) are titanium compounds, such as tetrabutyl or tetraisopropyl titanate, or titanium chelates, such as bis(ethylacetoacetato)diisobutoxytitanium, or organic tin compounds, such as di-n-butyltin dilaurate and di-n-butyltin diacetate, di-n-butyltin oxide, dimethyltin diacetate, dimethyltin dilaurate, dimethyltin dineodecanoate, dimethyltin oxide, di-n-octyltin diacetate, di-n-octyltin dilaurate, di-n-octyltin oxide, and reaction products of these compounds with alkoxysilanes, such as the reaction product of di-n-butyltin diacetate with tetraethoxysilane,

where preference is given to di-n-octyltin diacetate, di-n-octyltin dilaurate, di-n-octyltin oxide, reaction products of di-n-butyltin dilaurate, di-n-butyltin diacetate or di-n-octyltin oxide with tetraethoxysilane, tetrabutyl titanate, tetraisopropyl titanate or bis(ethylacetoacetato)diisobutoxytitanium and particular preference is given to di-n-octyltin diacetate, di-n-octyltin dilaurate, di-n-octyltin oxide or reaction products of di-n-butyltin dilaurate, di-n-butyltin diacetate or di-n-octyltin oxide with tetraethoxysilane.

If the compositions according to the invention comprise curing accelerators (D), this involves amounts of preferably 0.001 to 20 parts by weight, particularly preferably 0.001 to 1 part by weight, based in each case on 100 parts by weight of constituent (A).

Examples of plasticizers (E) optionally used are room-temperature-liquid dime-thylpolysiloxanes end-capped by trimethylsiloxy groups, in particular having viscosities at 25° C. in the range between 5 and 1000 mPas, and high-boiling hydrocarbons, such as paraffin oils or mineral oils consisting of naphthenic and paraffinic units.

If the compositions according to the invention comprise component (E), this involves amounts of preferably 5 to 30 parts by weight, preferably 5 to 25 parts by weight, based in each case on 100 parts by weight of siloxanes (A). The compositions according to the invention preferably do not comprise plasticizer (E).

The fillers (F) optionally used in the compositions according to the invention may be any previously known fillers.

Examples of fillers (F) optionally used are non-reinforcing fillers (F), i.e. fillers having a BET surface area of up to 20 m²/g, such as quartz, diatomaceous earth, calcium silicate, zirconium silicate, zeolites, metal oxide powders such as oxides or mixed oxides of aluminium, titanium, iron or zinc, barium sulfate, calcium carbonate, gypsum, silicon nitride, silicon carbide, boron nitride, glass and plastic powder, such as polyacrylonitrile powder; reinforcing fillers, i.e. fillers having a BET surface area of more than 20 m²/g, such as precipitated chalk and carbon black, such as furnace and acetylene black; silica, such as fumed silica and precipitated silica; fibrous fillers, such as plastic fibres.

The fillers (F) optionally used are preferably calcium carbonate or silica, particularly preferably silica or a mixture of silica and calcium carbonate.

Preferred calcium carbonate grades (F) are ground or precipitated and optionally surface-treated with fatty acids such as stearic acid or salts thereof. The preferred silica is preferably fumed silica.

If the compositions according to the invention comprise fillers (F), the amounts involved are preferably from 10 to 150 parts by weight, particularly preferably 10 to 130 parts by weight, especially 10 to 100 parts by weight, based in each case on 100 parts by weight of organopolysiloxanes (A). The compositions according to the invention preferably comprise filler (F).

Examples of additives (G) are pigments, dyes, fragrances, oxidation inhibitors, agents for influencing electrical properties, such as conductive carbon black, flame-retardant agents, light stabilisers, biocides such as fungicides, bactericides and acaricides, cell-generating agents, e.g. azodicarbonamide, heat stabilisers, scavengers, such as Si—N-containing silazanes or silylamides, e.g. N,N′-bis(trimethylsilyl)urea or hexamethyldisi-lazane, cocatalysts, thixotropic agents, such as polyethylene glycol terminated with OH on one or both ends or hardened castor oil, agents for further modulus regulation such as polydimethylsiloxanes having an OH end group, and any siloxanes other than components (A), (B) and (C).

Depending on the type and amount of the mixture (M) used as component (B) according to the invention, the addition of thixotropic agents (G) may be omitted.

The individual constituents of the compositions according to the invention may in each case be one kind of such a constituent or else a mixture of at least two different kinds of such constituents.

The compositions according to the invention are preferably those comprising
(A) organopolysiloxanes of the formula (V),
(B) mixtures (M),
optionally (C) silanes of the formula (VI) and/or partial hydrolysates thereof,
optionally (D) curing accelerators,
optionally (E) plasticizers,
optionally (F) fillers and
optionally (G) additives.

The compositions according to the invention are particularly preferably those comprising
(A) organopolysiloxanes of the formula (V),
(B) mixtures (M),
(C) silanes of the formula (VI) and/or partial hydrolysates thereof,
optionally (D) curing accelerators,
optionally (E) plasticizers,
optionally (F) fillers and
optionally (G) additives.

The compositions according to the invention are especially those comprising
(A) organopolysiloxanes of the formula (V),
(B) mixtures (M),
(C) silanes of the formula (VI) and/or partial hydrolysates thereof,
(D) curing accelerators,
(F) fillers,
optionally (E) plasticizers and
optionally (G) additives.

The compositions according to the invention preferably comprise no further constituents other than components (A) to (G).

The compositions according to the invention are preferably viscous to pasty masses.

To prepare the compositions according to the invention, all constituents can be mixed with one another in any sequence. This mixing may be carried out at room temperature and the pressure of the ambient atmosphere, i.e. about 900 to 1100 hPa. If desired, however, this mixing may also be effected at higher temperatures, for example temperatures in the range from 35 to 135° C. Furthermore, it is possible to mix inter-mittently or constantly under reduced pressure, such as at 30 to 500 hPa absolute pressure, to remove unwanted volatile compounds or air.

The mixing according to the invention preferably takes place with the greatest possible exclusion of water from the atmosphere. All raw materials with the exception of (M) have a water content of preferably less than 10 000 mg/kg, preferably of less than 5000 mg/kg, especially of less than 1000 mg/kg. During the mixing process, dry air or protective gas such as nitrogen is preferably used, the respective gas having a moisture content of preferably less than 10 000 μg/kg, preferably less than 1000 μg/kg, especially less than 500 μg/kg. After preparation, the pastes are filled into commercially available moisture-proof containers, such as cartridges, tubular bags, buckets and drums.

In a preferred procedure, components (A), optionally (C) and (E) are first mixed together, then optionally fillers (F) are added and finally (B) and optionally further components (D) and (G) are added, wherein preferably the temperature during mixing does not exceed 60° C.

The invention further provides a process for preparing the compositions according to the invention by mixing the individual constituents.

The process according to the invention may be carried out continuously, discontinuously or semi-continuously by known methods and using known apparatuses.

The compositions according to the invention or prepared according to the invention may be stored with exclusion of moisture and are crosslinkable on ingress of moisture.

The usual water content of air is sufficient for the crosslinking of the compositions according to the invention. The compositions according to the invention are preferably crosslinked at room temperature. They may, if desired, also be crosslinked at temperatures higher or lower than room temperature, for example at −5° C. to 15° C. or at 30° C. 10 to 50° C. and/or using concentrations of water exceeding the normal water content of air.

The crosslinking is preferably conducted at a pressure of 100 to 1100 hPa, in particular at the pressure of the surrounding atmosphere, i.e. about 900 to 1100 hPa.

The present invention further provides mouldings produced by crosslinking the compositions according to the invention.

The compositions according to the invention can be used for all purposes for which it is possible to use compositions which are storable with the exclusion of water and crosslink to give elastomers on ingress of water at room temperature.

The compositions according to the invention thus have excellent suitability, for example, as sealants for joints, including vertical joints, and similar cavities of, for example, 10 to 40 mm internal width, for example of buildings, land vehicles, watercraft and air-craft, or as adhesives or cementing compositions, for example in window construction or in the production of glass cabinets and, for example, for production of protective coatings, including those for surfaces exposed to the constant action of fresh or sea water, or anti-slip coatings, or of elastomeric mouldings.

The compositions according to the invention have the advantage that they are easy to produce and are characterized by a very high storage stability.

Further preferably, the mixtures (M) according to the invention may be used as neutralizing agents in processes for the preparation of polymers having hydrolysable end groups.

The invention further provides a process for preparing organosilicon compounds comprising organyloxy groups, characterized in that in a 1st step organosilicon compound (a) comprising at least one silanol group is reacted with compound (b) comprising at least two organyloxy groups in the presence of strongly basic catalysts (c) and in a 2nd step, after reaction of the hydroxyl groups of component (a) with the compounds (b) comprising organyloxy groups has taken place, the mixture (M) according to the invention is added.

In the process according to the invention, the strongly basic catalysts (c) may be lithium compounds, such as lithium alkoxylates or lithium hydroxide, and amidines or guanidines, with cyclic guanidines being preferred as component (c), with particular preference being given to 1,5,7-triazabicyclo[4.4.0]dec-5-ene.

In a preferred embodiment of the process according to the invention, in a 1st step organosilicon compound (a) comprising at least one silanol group is reacted with compound (b) comprising at least two organyloxy groups, in the presence of 1,5,7-triazabicyclo[4.4.0]dec-5-ene (c) and in a 2nd step mixture (M) according to the invention is added.

The component (a) used according to the invention may be any organosilicon compounds known to date having at least one silanol group.

Organosilicon compound (a) is preferably an organosilicon compound having at least two silanol groups.

Organosilicon compounds (a) are preferably substantially linear organopolysiloxanes.

The organosilicon compounds (a) used in accordance with the invention have a viscosity of preferably 10² to 10⁸ mPas, particularly preferably of 1000 to 350 000 mPas, in each case at 25° C.

Examples of organosilicon compounds (a) used in accordance with the invention are
HO(Si(CH₃)₂O)₂₉₋₁₀₀₀Si(CH₃)₂(CH₂)₃NH₂,
HO(Si(CH₃)₂O)₂₉₋₁₀₀₀Si(CH₃)₂(OH),
HO(Si(CH₃)₂O)₂₉₋₁₀₀₀Si(CH₃)₃,
HO(Si(CH₃)₂O)₀₋₁₀₀Si(CH₃)₂(CH₂)₃O(CH₂CH(CH₃)O)₁₀₋₁₀₀₀(CH₂)₃(Si(CH₃)₂O)₀₋₁₀₀Si(CH₃)₂(OH),
HO(Si(CH₃)₂O)₃₋₅₀₀Si(O)₃[(Si(CH₃)₂O)₃₋₅₀₀H]₃ and
HO(Si(CH₃)₂O)₃₋₅₀₀Si(CH₃)(O)₂[(Si(CH₃)₂O)₃₋₅₀₀H]₂,
where preference is given to HO(Si(CH₃)₂O)₃₀₋₁₀₀₀Si(CH₃)₂(CH₂)₃NH₂,
HO(Si(CH₃)₂O)₃₀₋₁₀₀₀Si(CH₃)₂(OH),
HO(Si(CH₃)₂O)₃₀₋₁₀₀₀Si(CH₃)₃ and
HO(Si(CH₃)₂O)₃₋₅₀₀Si(CH₃)(O)₂[(Si(CH₃)₂O)₃₋₅₀₀H]₂
and particular preference is given to HO(Si(CH₃)₂O)₃₀₋₁₀₀₀Si(CH₃)₂(OH).

Components (a) are commercially available products or can be prepared by standard chemical methods.

The component (b) used according to the invention can be any previously known compounds having at least two organyloxy groups, preferably siloxanes or silanes.

Component (b) are particularly preferably silanes of the formula (VI) and/or partial hydrolysates thereof.

Examples of compound (b) used according to the invention are methyltrimethoxysilane, dimethyldimethoxysilane, tetramethoxysilane, vinyltrimethoxysilane, methylvinyldimethoxysilane, methyltriethoxysilane, tetraethoxysilane, phenyltrimethoxysilane, n-butyltrimethoxysilane, isobutyltrimethoxysilane and tert-butyltrimethoxysilane, and partial hydrolysates thereof, wherein preference is given to methyltrimethoxysilane, tetramethoxysilane, vinyltrimethoxysilane, methylvinyldimethoxysilane, methyltriethoxysilane, tetraethoxysilane and n-butyltrimethoxysilane and particular preference is given to methyltrimethoxysilane, tetramethoxysilane, vinyltrimethoxysilane, tetraethoxysilane and n-butyltrimethoxysilane.

Components (b) are commercially available products or can be prepared by standard chemical methods.

In the process according to the invention, component (b) is preferably used in 1 to 100-fold excess, particularly preferably in 2 to 50-fold molar excess, based in each case on the molar amount of Si—OH groups in compound (a).

In the process according to the invention, catalyst (c) is used in amounts of preferably 5 to 10 000 ppm by weight, particularly preferably 100 to 3000 ppm by weight, based in each case on the total amount of component (a) and (b).

In the process according to the invention, the individual components can be mixed with one another in any sequence and in any manner known to date. Premixes can also be prepared from some components, such as a mixture of components (b) and (c), which are then mixed with the other components. Individual constituents may also be present or be fed right at the start or during the mixing process. For instance, some of component (b) or preparation (c) may only be added 1 to 60 minutes after the mixing of the other respective constituents.

The components used in the process according to the invention may each be one type of such component or else a mixture of at least two types of a respective component.

The process according to the invention is preferably carried out at ambient temperatures, or the temperatures resulting from mixing the individual components, without additional heating. These are preferably temperatures of 10 to 60° C., particularly preferably 15 to 40° C.

The process according to the invention is preferably carried out at the pressure of the surrounding atmosphere, i.e. 900 to 1100 hPa; however, it is also possible to operate at positive pressure, such as at pressures between 1100 and 3000 hPa absolute pressure, particularly in the case of continuous operation if, for example, these pressures arise in closed systems due to the pressure when pumping and due to the vapour pressure of the materials used at elevated temperatures.

The process according to the invention is preferably carried out with exclusion of moisture, such as in dry air or nitrogen.

The process according to the invention may—if desired—be carried out under protective gas such as nitrogen.

In the process according to the invention, the reaction mixture can be devolatilized after termination of the reaction, the devolatilization being carried out by means of reduced pressure in the same apparatus or in a downstream apparatus, with or without inert gas feed, at room temperatures or elevated temperatures. The highly volatile constituents are preferably alcohols such as methanol or ethanol.

The process according to the invention may be carried out continuously or discontinuously.

A plurality of organosilicon compounds comprising organyloxy groups may be prepared advantageously by the process according to the invention.

The process according to the invention has the advantage that organosilicon compounds comprising organyloxy groups may be prepared in a simple manner.

In the examples described below, all viscosity data are based on a temperature of 25° C. Unless stated otherwise, the examples that follow are conducted at a pressure of the surrounding atmosphere, that is to say at around 1000 hPa, and at room temperature, that is to say at around 23° C., or at a temperature as results when combining the reactants at room temperature without supplemental heating or cooling, and at a relative humidity of about 50%. In addition, unless otherwise stated, all reported parts and percentages relate to weight.

In the context of the present invention, the dynamic viscosity of the organosilicon compounds is measured in accordance with DIN 53019. The preferred procedure was as follows: unless otherwise stated, the viscosity is measured at 25° C. using a “Physica MCR 300” rotational rheometer from Anton Paar. In this case, a coaxial cylinder measuring system (CC 27) with an annular measuring gap of 1.13 mm is used for viscosities of from 1 to 200 mPa·s, and a cone-plate measuring system (Searle system with CP 50-1 measuring cone) is used for viscosities of greater than 200 mPa·s. The shear rate is adapted to the polymer viscosity (1 to 99 mPa·s at 100 s¹; 100 to 999 mPa·s at 200 s¹; 1000 to 2999 mPa·s at 120 s¹; 3000 to 4999 mPa·s at 80 s¹; 5000 to 9999 mPa·s at 62 s¹; 10 000 to 12 499 mPa·s at 50 s¹; 12 500 to 15 999 mPa·s at 38.5 s¹; 16 000 to 19 999 mPa·s at 33 s¹; 20 000 to 24 999 mPa·s at 25 s¹; 25 000 to 29 999 mPa·s at 20 s¹; 30 000 to 39 999 mPa·s at 17 s¹; 40 000 to 59 999 mPa·s at 10 s¹; 60 000 to 149 999 mPa·s at 5 s¹; 150 000 to 199 999 mPa·s at 3.3 s¹; 200 000 to 299 999 mPa·s at 2.5 s¹; 300 000 to 1 000 000 mPa·s at 1.5 s¹).

The number-average molar mass Mo is determined in the context of the present invention by size-exclusion chromatography (SEC) on a Styragel HR3-HR4-HR5-HR5 col-umn set from Waters Corp. USA in THE with an injected volume of 100 μl against a polystyrene standard at 60° C., a flow rate of 1.2 ml/min, and detection by RI (refractive index detector).
PPG 425: polypropylene glycol having an average molecular weight Mn of 425 g/mol;
PPG 1000: polypropylene glycol having an average molecular weight Mn of 1000 g/mol;
PPG 400: polypropylene glycol having an average molecular weight Mo of 400 g/mol;
OPS 75: n-octylphosphonic acid, 75% by weight in water and ethanol (commercially available, for example, under the name “Hostaphat OPS 75” from Clariant).

### EXAMPLE 1

100 g of OPS 75 were mixed with 75 g of PPG 425 and heated to 105° C. under reduced pressure of 20 mbar and maintained at this temperature for one hour. Here, the ethanol and water distil off.

A clear solution was obtained which starts to crystallize at 28° C. and is solid at room temperature.

The results can be found in Table 1.

### EXAMPLE 2

100 g of OPS 75 were mixed with 75 g of PPG 1000 and heated to 105° C. under reduced pressure of 20 mbar and maintained at this temperature for one hour. Here, the ethanol and water distil off.

A clear solution was obtained which starts to crystallize at 25° C. and is solid at room temperature. Therefore, no viscosity could be measured at 25° C.

The results can be found in Table 1.

### EXAMPLES 4 TO 7

The procedure described in example 1 was repeated with the amounts of feedstocks stated in Table 1.

In examples 4 and 7, after completion of the distillation phase, the mixture was cooled to 80° C. and the amounts of deionized water specified in Table 1 were added. In order to obtain homogeneous solutions, stirring was continued for a further hour in these cases. Clear solutions were obtained with the viscosities and temperatures of onset of crystallization stated in Table 1.

TABLE 1

| | OPS | PPG | PPG | | Viscosity | Onset of | |
|---|---|---|---|---|---|---|---|
| | 75 | 425 | 1000 | H2O | at 25° C. | crystal- | |
| Example | [g] | [g] | [g] | [g] | [mPas] | lization | |
| 1 | 100 | 75 | | | * | +28° | C. |
| 2 | 100 | | 80 | | * | +25° | C. |
| 4 | 100 | 80 | | 7.12 | 341 | −10° | C. |
| 5 | 100 | 150 | | | 251 | −5° | C. |
| 6 | 100 | 225 | | | 180 | −25° | C. |
| 7 | 100 | 150 | | 10.64 | 252 | <−30° | C. |

* not measurable due to crystallization

### EXAMPLE 8

The procedure described in example 7 was repeated, with the modification that PPG 400 was used instead of PPG 425. No differences were observed in this case. In particular, the melting point was likewise less than −30° C.

### EXAMPLE 9

309 g of an α,ω-bis[(tetrahydro-1,4-oxazin-4-yl)methyldiethoxysilyl]polydimethylsiloxane having a viscosity of 80 000 mPa·s, 130 g of an α,ω-bis(trimethylsiloxy)polydimethylsiloxane having a viscosity of 1000 mPa·s (commercially available under the name “Weichmacher 1000” from Wacker Chemie AG, Munich, Germany), 1 g of a product consisting of 16.0 mol % of units of the formula MeSi(OEt)₂O_{1/2}, 46.4 mol % of units of the formula MeSi(OEt)O_{2/2}, 36.5 mol % of units of the formula MeSiO_{3/2}, 0.2 mol % of units of the formula Me₂Si(OEt)O_{1/2} and 0.9 mol % of units of the formula Me₂SiO_{2/2}, 8 g of 3-aminopropyltriethoxysilane (commercially available under the name GENIOSIL® GF 93 from Wacker Chemie AG, Munich, Germany), 2 g of vinyltriethoxysilane (commercially available under the name GENIOSIL® GF 56 from Wacker Chemie AG, Munich, Germany) and 5 g of tetraethyl silicate (commercially available under the name “Silikat TES 28” from Wacker Chemie AG, Munich, Germany) were initially charged in a planetary mixer and mixed for a period of 30 minutes. 45 g of a fumed silica having a BET specific surface area of 150 m²/g (commercially available under the name HDK® V15 from Wacker Chemie AG, Munich, Germany) were then mixed in and the mixture was completely homogenized at a pressure of 50 hPa. Lastly, 1 g of the mixture prepared in example 1 and 2 g of a reaction product of dibutyltin diacetate and tetraethoxysilane (commercially available under the name “Katalysator 41” from Wacker Chemie AG, Munich, Germany) were added and the mixture was homogenized for a further 5 minutes at a pressure of ca. 50 hPa (absolute).

The RTV1 composition thus obtained was filled into commercially available moisture-proof polyethylene cartridges and stored at room temperature for 24 h and a further sample at 70° C. for 7 days. Then, from each of these samples thus stored, slabs of 2 mm thickness were spread out and stored at 23° C. and 50% relative humidity for 7 days. Test specimens according to DIN 53504 of form S2 were punched out of the cured materials and the mechanical characteristics were measured. The results can be found in Table 2.

### EXAMPLE 10

Example 9 was repeated with the modification that 1.57 g of a mixture according to example 7 were added instead of 1 g of the mixture according to example 1.

The results can be found in Table 2.

### EXAMPLE 11

880 kg of an α,ω-dihydroxypolydimethylsiloxane having a viscosity of 80 000 mPa·s (commercially available under the name POLYMER FD 80 from Wacker Chemie AG, Munich, Germany) were mixed with a solution of 91 g of triazabicyclo[4.4.0]dec-5-ene in 27 kg of vinyltrimethoxysilane (commercially available under the name GENIOSIL® XL 10 from Wacker Chemie AG, Munich, Germany). After a reaction time of 45 minutes at room temperature, 255 g of the mixture according to example 1 were added and mixed homogeneously.

An α,ω-bis(vinyldimethoxysilyl)polydimethylsiloxane having a viscosity of 100 Pas was obtained without further work-up as a clear colourless product.

### EXAMPLE 12

300 g of the product prepared according to example 11 were initially charged in a planetary mixer with 130 g of an α,ω-bis(trimethylsiloxy)polydimethylsiloxane having a viscosity of 1000 mPa·s (commercially available under the name “Weichmacher 1000” from Wacker Chemie AG, Munich, Germany), 5 g of N-(2-aminoethyl)-3-ami-nopropyltrimethoxysilane (commercially available under the name GENIOSIL® GF 91 from Wacker Chemie AG, Munich, Germany), 2 g of vinyltrimethoxysilane (commercially available under the name GENIOSIL® XL 10 from Wacker Chemie AG, Munich, Germany) and mixed for a period of 30 minutes. 45 g of a fumed silica having a BET specific surface area of 150 m²/g (commercially available under the name HDK® V15 from Wacker Chemie AG, Germany (Munich)), were then mixed in and the mixture was completely homogenized at a pressure of 50 hPa. Lastly, 1 g of a solution according to example 1 and 2 g of a reaction product of dibutyltin diacetate and tetraethoxysilane (commercially available under the name “Katalysator 41” from Wacker Chemie AG, Munich, Germany) were added and the mixture was homogenized for a further 5 minutes at a pressure of ca. 50 hPa (absolute).

The RTV1 composition thus obtained was filled into commercially available moisture-proof polyethylene cartridges and stored at room temperature for 24 h and a further sample at 70° C. for 7 days. Then, from each of these samples thus stored, slabs of 2 mm thickness were spread out and stored at 23° C. and 50% relative humidity for 7 days. Test specimens according to DIN 53504 of form S2 were punched out of the cured materials and the mechanical characteristics were measured.

The results can be found in Table 2.

### EXAMPLE 13

Preparation of an Oligomeric Mixture 13a:

240 g (3.25 mol) of an α,ω-bis(trimethylsiloxy)polydimethylsiloxane having a viscosity of 1000 mPas, 234 g (1.0 mol) of trimethoxy(2,4,4-trimethylpentyl)silane (=iOctSi(OMe)₃), obtainable from Wacker Chemie AG under the name SILRES® BS 1316, and 0.80 g of a solution of sodium ethoxide (21%) in ethanol are mixed and heated to 110° C. for 4 hours. After cooling the solution, the mixture is neutralized by adding 1.60 g of a solution of dimethyldichlorosilane (10%) in n-heptane. This mixture was devolatilized on a rotary evaporator at 120° C. at a reduced pressure of 50 mbar. The composition of the mixture was determined by ²⁹Si-NMR spectroscopy. The mixture comprised 1.4% by weight iOctSi(OMe)₃, 0.4% by weight Me₂Si(OMe)₂ and 98.2% by weight of an oligomeric mixture of average composition of [iOctSi(OMe)₂O_{1/2}]_{0.08}[iOctSi(OMe)O_{2/2}]_{0.15}[iOctSiO_{3/2}]_{0.05} [Me₂SiO₂/2]_{0.43}[Me₂Si(OMe)O_{1/2}]_{0.29}. The molecular weights determined by gel permeation chromatography were 929 g/mol (Mw—weight average) and 635 (Mn—number average). The polydispersity (Mw/Mn) was 1.46.

A mixture of 660 g of an α,ω-dihydroxypolydimethylsiloxane having a viscosity of 80 000 mPas and 220 g of an α,ω-dihydroxypolydimethylsiloxane having a viscosity of 20 20 000 mPas was stirred with 30.44 g of a solution of 0.04 g of 1,5,7-triazabicyclo[4.4.0]dec-5-ene in 30.4 g of (2,3,5,6-tetrahydro-1,4-oxazin-4-yl)methyltriethoxysilane at 200 revolutions/min for 5 minutes. After a reaction time of 5 minutes, this gives a mixture of 98.0% by weight a,w-bis((2,3,5,6-tetrahydro-1,4-oxazin-4-yl)methyl-diethoxysilyl)polydimethylsiloxane, 1.9% by weight (2,3,5,6-tetrahydro-1,4-oxazin-4-yl)methyltriethoxysilane and 0.1% by weight ethanol having a viscosity of 52 000 mPas.

RTV1-Sealing Compound Using the Oligomeric Mixture 13a:

455 g of the reaction mixture thus obtained were added to 10.6 g of tetraethoxysilane hydrolysate oligomer having a content of SiO₂ of 40% on total hydrolysis and condensation, available from Wacker Chemie AG, Munich, Germany, under the name “SILIKAT TES 40”, 12.6 g of an equilibration product of 6.3 g of methyltriethoxysilane hydrolysate oligomers having an average of 10 Si atoms per molecule and 6.3 g of 3-aminopropyltriethoxysilane, and the mixture stirred for a further 5 minutes at 200 revo-lutions/min. Then, 44 g of a hydrophilic fumed silica having a surface area of 150 m²/g, available from Wacker Chemie AG under the name HDK® V15A, were added and the mixture stirred initially at 200 revolutions/min for a further 5 minutes until all the fumed silica had been wetted. The mixture was then stirred at 600 revolutions/min for 10 minutes at a reduced pressure of 200 mbar. Finally, 1.58 g of a solution of 0.27 g of dioctyltin oxide in 1.31 g of an equilibration product of 0.655 g of methyltriethoxysilane hydrolysate oligomers having an average of 10 Si atoms per molecule and 0.655 g of 3-aminopropyltriethoxysilane and 2.6 g of the additive of the invention according to example 7 and 25.6 g of the oligomeric mixture 13a were added and the mixture stirred for a further 5 minutes under reduced pressure (200 mbar).

The mixture is then filled into commercially available cartridges and stored with exclusion of moisture. 24 h after preparation of the mixtures, 2 mm thick slabs were drawn out from these mixtures and dumbbell-shaped test specimens of type 2, according to ISO 37, 6th edition 2017-11, were produced therefrom after curing for 7 days at 23° C. and 50% relative humidity.

The results can be found in Table 2.

Without the additive of the invention according to example 7, a mixture analogous to example 13 no longer cured to a tack-free material after pre-storage at 70° C. for 7 days.

TABLE 2
Mechanical characteristics

| | | | | Tensile |
|---|---|---|---|---|
| | | Tensile | Elongation | stress at |
| | | strength | at break | 100% elongation |
| Example | Pre-storage | (MPa) | (%) | (MPa) |
| 9 | 24 h, RT | 1.1 | 360 | 0.43 |
| 9 | 7 d, 70° C. | 1.3 | 460 | 0.40 |
| 10 | 24 h, RT | 1.5 | 460 | 0.43 |
| 10 | 7 d, 70° C. | 1.5 | 520 | 0.39 |
| 12 | 24 h, RT | 1.4 | 430 | 0.44 |
| 12 | 7 d, 70° C. | 1.3 | 420 | 0.42 |
| 13 | 24 h, RT | 2.1 | 260 | 0.73 |
| 13 | 7 d, 70° C. | 2.0 | 280 | 0.69 |

The skin formation times were each in the usual range of between 15 and 25 minutes. Without the additives according to the invention, the mixtures according to examples 9, 10, 12 and 13 no longer cured to tack-free materials after pre-storage for 7 days at 70° C.

### EXAMPLE 14

In a laboratory dissolver, 400 g of the α,ω-dihydroxypolydimethylsiloxane were intensively mixed with 8.5 g of phenyltrimethoxysilane and 0.25 g of a solution of 20% by mass 1,5,7-triazabicyclo[4.4.0]dec-5-ene in isooctyltriethoxysilane at an initial temperature of 25° C. for 5 minutes. The mixing shaft with dissolver gear ring, the diameter of which was ca. 5 cm, was set to 1000 revolutions per minute.

That the mixture was free of silanol groups after 30 minutes was established by means of the titanate rapid test described in EP 2 170 995 B1 on page 7. The endcap-ping reaction was thus already complete at this timepoint.

Subsequently, 0.5 g of the additive according to the invention from example 7 was mixed in over 10 min.
Viscosity after 2 hours: 90.0 Pa·s
Viscosity after 22 hours: 85.5 Pa·s

### EXAMPLE 15 (NON-INVENTIVE)

Experiment 13 was repeated with the modification that no additive according to the invention was subsequently mixed in.
Viscosity after 2 hours: 89.0 Pa·s
Viscosity after 22 hours: 48.5 Pa·s

It can be seen that without the stabilizer according to the invention there is a sharp loss of viscosity.

### EXAMPLE 16

In a laboratory dissolver, 400 g of the α,ω-dihydroxypolydimethylsiloxane were intensively mixed with 7 g of 4-(triethoxysilylmethyl)tetrahydro-1,4-oxazine and 0.25 g of a solution of 20% by mass 1,5,7-triazabicyclo[4.4.0]dec-5-ene in isooctyltriethoxysilane at an initial temperature of 25° C. for 5 minutes. The mixing shaft with dissolver gear ring, the diameter of which was ca. 5 cm, was set to 1000 revolutions per minute.

That the mixture was free of silanol groups after 30 minutes was established by means of the titanate rapid test described in EP 2 170 995 B1 on page 7. The endcap-ping reaction was thus already complete at this timepoint.

Subsequently, 0.5 g of the additive according to the invention from example 7 was mixed in over 10 min.
Viscosity after 2 hours: 190.0 Pa·s
Viscosity after 22 hours: 162.5 Pa·s

### EXAMPLE 17 (NON-INVENTIVE)

Experiment 15 was repeated with the modification that no additive according to the invention was subsequently mixed in.
Viscosity after 2 hours: 184.5 Pa·s
Viscosity after 22 hours: 113.0 Pa·s

It can again be seen that without the additive according to the invention, there is an extreme reduction in viscosity.

1-11. (canceled)

12. Mixtures (M), comprising:
a compound (X) of polyethers of the general formula (I)
R¹—(O—R²)ₚ—O—R¹ (I),
wherein R¹ may be identical or different and denotes a hydrogen atom or hydrocarbon radicals;
wherein R² may be identical or different and denotes divalent, optionally substituted hydrocarbon radicals;
wherein p is an integer from 4 to 110;
a compound (Y) of phosphorus compounds of the general formula (II)
O═PR⁵ₘ(OR⁶)ₙ(OH)₃₋₍ₘ₊ₙ₎ (II),
wherein R⁵ may be identical or different and denotes optionally substituted hydrocarbon radicals;
wherein R⁶ may be identical or different and denotes optionally substituted hydrocarbon radicals;
wherein m is equal to 0 or 1, preferably 1;
wherein n is equal to 0, 1 or 2;
wherein m+n is equal to 1 or 2, preferably 1; and
optionally a compound (Z) being an amount of water.

13. The mixtures (M) of claim 12, wherein the compound (X) of polyethers are those of the formula
R¹(OCH₂CH₂)_{q}(OCHCH₃CH₂)ᵣ(OCH₂CH₂)ₛOR¹ (III);
wherein R¹ has one of the aforementioned definitions;
wherein q is 0 or an integer from 1 to 30, preferably 0 or an integer from 1 to 15;
wherein s is 0 or an integer from 1 to 30, preferably 0 or an integer from 1 to 15, and
wherein r is an integer from 4 to 50, preferably an integer from 4 to 35.

14. The mixtures (M) of claim 12, wherein the compound (Y) of phosphorus are alkylphosphonic acids having 4 to 18 carbon atoms.

15. The mixtures (M) of claim 12, wherein the mixtures comprise compound (Y) of phosphorus in amounts of 10 to 50 parts by weight.

16. The mixtures (M) of claim 12, wherein the mixtures comprise the water (Z) in amounts of 0.5 to 3.0 mol, based on 1 mole of the compound (Y) of phosphorus.

17. Process for preparing mixtures (M), comprising:
providing a compound (X) of polyethers of the general formula (I), a compound (Y) of phosphorus compounds of the formula (II) and optionally a compound (Z) being an amount of water,
wherein the general formula (I) is
R¹—(O—R²)ₚ—O—R¹ (I),
wherein R¹ may be identical or different and denotes a hydrogen atom or hydrocarbon radicals,
wherein R² may be identical or different and denotes divalent, optionally substituted hydrocarbon radicals, and
wherein p is an integer from 4 to 110,
wherein the formula (II) is
O═PR⁵ₘ(OR⁶)ₙ(OH)₃₋₍ₘ₊ₙ₎ (II),
wherein R⁵ may be identical or different and denotes optionally substituted hydrocarbon radicals,
wherein R⁶ may be identical or different and denotes optionally substituted hydrocarbon radicals,
wherein m is equal to 0 or 1, preferably 1,
wherein n is equal to 0, 1 or 2,
wherein m+n is equal to 1 or 2, preferably 1; and
mixing the individual constituents together.

18. A process for preparing crosslinkable compositions based on organosilicon compounds, comprising:
providing (A) of organopolysiloxanes of the formula (V)
(R⁷O)₃₋ₐSiR³ₐO(SiR⁴₂O)ₓSiR³ₐ(OR⁷)₃₋ₐ (V),
wherein R⁴ may be identical or different and denotes monovalent, optionally substituted hydrocarbon radicals,
wherein R⁷ may be identical or different and denotes monovalent, optionally substituted hydrocarbon radicals,
wherein R³ may be identical or different and denotes monovalent, optionally substituted hydrocarbon radicals,
wherein a may be identical or different and is 0 or 1, preferably 1,
wherein x is an integer from 30 to 2000;
providing (B) mixtures (M), wherein the mixtures (M) comprise a compound (X) of polyethers of the general formula (I), a compound (Y) of phosphorus compounds of the formula (II) and optionally a compound (Z) being an amount of water,
wherein the general formula (I) is
R¹—(O—R²)ₚ—O—R¹ (I),
wherein R¹ may be identical or different and denotes a hydrogen atom or hydrocarbon radicals,
wherein R² may be identical or different and denotes divalent, optionally substituted hydrocarbon radicals,
wherein p is an integer from 4 to 110,
wherein the formula (II) is
O═PR⁵ₘ(OR⁶)ₙ(OH)₃₍ₘ₊ₙ₎ (II),
wherein R⁵ may be identical or different and denotes optionally substituted hydrocarbon radicals,
wherein R⁶ may be identical or different and denotes optionally substituted hydrocarbon radicals,
wherein m is equal to 0 or 1, preferably 1,
wherein n is equal to 0, 1 or 2,
wherein m+n is equal to 1 or 2, preferably 1; and
mixing the individual constituents together.

19. The process of claim 18, wherein the crosslinkable compositions obtained are mouldings.

20. Compositions, comprising:
(A) organopolysiloxanes of the formula (V), (B) mixtures (M), and optionally (C) silanes of the formula (VI) and/or partial hydrolysates thereof, optionally (D) curing accelerators, optionally (E) plasticizers, optionally (F) fillers and optionally (G) additives;
wherein the mixtures (M) comprise a compound (X) of polyethers of the general formula (I), a compound (Y) of phosphorus compounds of the formula (II) and optionally a compound (Z) being an amount of water;
wherein the general formula (I) is
R¹—(O—R²)ₚ—O—R¹ (I),
wherein R¹ may be identical or different and denotes a hydrogen atom or hydrocarbon radicals,
wherein R² may be identical or different and denotes divalent, optionally substituted hydrocarbon radicals,
wherein p is an integer from 4 to 110;
wherein the general formula (II) is
O═PR⁵ₘ(OR⁶)ₙ(OH)₃₍ₘ₊ₙ₎ (II),
wherein R⁵ may be identical or different and denotes optionally substituted hydrocarbon radicals,
wherein R⁶ may be identical or different and denotes optionally substituted hydrocarbon radicals,
wherein m is equal to 0 or 1, preferably 1,
wherein n is equal to 0, 1 or 2,
wherein m+n is equal to 1 or 2, preferably 1; and
wherein the formula (V) is
(R⁷O)₃₋ₐSiR³ₐO(SiR⁴₂O)ₓSiR³ₐ(OR⁷)₃₋ₐ (V),
wherein R⁴ may be identical or different and denotes monovalent, optionally substituted hydrocarbon radicals,
wherein R⁷ may be identical or different and denotes monovalent, optionally substituted hydrocarbon radicals,
wherein R³ may be identical or different and denotes monovalent, optionally substituted hydrocarbon radicals,
wherein a may be identical or different and is 0 or 1, preferably 1, and
wherein x is an integer from 30 to 2000.

21. The process of claim 20, compositions obtained are mouldings.

22. Process for preparing the compositions, comprising: providing (A) organopolysiloxanes of the formula (V), (B) mixtures (M), and optionally
(C) silanes of the formula (VI) and/or partial hydrolysates thereof, optionally (D) curing accelerators, optionally (E) plasticizers, optionally (F) fillers and optionally (G) additives,
wherein the mixtures (M) comprise a compound (X) of polyethers of the general formula (I), a compound (Y) of phosphorus compounds of the formula (II) and optionally a compound (Z) being an amount of water;
wherein the general formula (I) is
R¹—(O—R²)ₚ—O—R¹ (I),
wherein R¹ may be identical or different and denotes a hydrogen atom or hydrocarbon radicals,
wherein R² may be identical or different and denotes divalent, optionally substituted hydrocarbon radicals,
wherein p is an integer from 4 to 110;
wherein the general formula (II) is
O═PR⁵ₘ(OR⁶)ₙ(OH)₃₋₍ₘ₊ₙ₎ (II),
wherein R⁵ may be identical or different and denotes optionally substituted hydrocarbon radicals,
wherein R⁶ may be identical or different and denotes optionally substituted hydrocarbon radicals,
wherein m is equal to 0 or 1, preferably 1,
wherein n is equal to 0, 1 or 2,
wherein m+n is equal to 1 or 2, preferably 1; and
wherein the formula (V) is
(R⁷O)₃₋ₐSiR³ₐO(SiR⁴₂O)ₓSiR³ₐ(OR⁷)₃₋ₐ (V),
wherein R⁴ may be identical or different and denotes monovalent, optionally substituted hydrocarbon radicals,
wherein R⁷ may be identical or different and denotes monovalent, optionally substituted hydrocarbon radicals,
wherein R³ may be identical or different and denotes monovalent, optionally substituted hydrocarbon radicals,
wherein a may be identical or different and is 0 or 1, preferably 1,
wherein x is an integer from 30 to 2000; and
mixing the individual constituents.

23. The process of claim 22, compositions obtained are mouldings.

24. A process for preparing organosilicon compounds comprising organyloxy groups; comprising:
wherein in a 1st step an organosilicon compound (a) comprising at least one silanol group is reacted with a compound (b) comprising at least two organyloxy groups, in the presence of catalysts (c), which are selected from lithium alkoxylates, lithium hydroxide, amidines or guanidines;
wherein in a 2nd step, after reaction of the hydroxyl groups of the component (a) with the compounds (b) comprising organyloxy groups has taken place, the mixture (M) according to the invention is added,
wherein the mixtures (M) comprise a compound (X) of polyethers of the general formula (I), a compound (Y) of phosphorus compounds of the formula (II) and optionally a compound (Z) being an amount of water;
wherein the general formula (I) is
R¹—(O—R²)ₚ—O—R¹ (I),
wherein R¹ may be identical or different and denotes a hydrogen atom or hydrocarbon radicals,
wherein R² may be identical or different and denotes divalent, optionally substituted hydrocarbon radicals,
wherein p is an integer from 4 to 110;
wherein the general formula (II) is
O═PR⁵ₘ(OR⁶)ₙ(OH)₃₋₍ₘ₊ₙ₎ (II),
wherein R⁵ may be identical or different and denotes optionally substituted hydrocarbon radicals,
wherein R⁶ may be identical or different and denotes optionally substituted hydrocarbon radicals,
wherein m is equal to 0 or 1, preferably 1,
wherein n is equal to 0, 1 or 2, and
wherein m+n is equal to 1 or 2, preferably 1.
